(19) United States
(12) Patent Application Publication
(10) Pub. No.: US 2013/0314418 A1
(43) Pub. Date: Nov. 28, 2013

(54) System for Erasing Medical Image Features

(71) Applicant: Komal Dutta, Hoffman Estates, IL (US)

(72) Inventor: Komal Dutta, Hoffman Estates, IL (US)

(73) Assignee: Siemens Medical Solutions USA, Inc., Malvern, PA (US)

(21) Appl. No.: 13/873,275

(22) Filed: Apr. 30, 2013

Related U.S. Application Data
(60) Provisional application No. 61/651,069, filed on May 24, 2012.

(51) Int. Cl. G06T 19/20

(52) U.S. Cl. CPC G06T 19/20
USPC 345/426

(57) ABSTRACT

A system erases features in a displayable three dimensional (3D) medical image volume comprising multiple image slices. An erasure cursor coordinate detector detects two dimensional (2D) location coordinates identifying location of a movable erasure cursor in a displayed image within the medical image volume. A data processor translates the detected erasure cursor 2D location coordinates to corresponding 2D pixel coordinates within an image slice in the 3D medical image volume. The data processor sets luminance values of pixels corresponding to the 2D pixel coordinates of the image slice to a background luminance value of the image slice to provide erased pixels corresponding to erasure cursor locations having an identifier. A display processor generates data representing a display image showing the image slice with the set background luminance values of the erased pixels.

This is a non-provisional application of provisional application Ser. No. 61/651,069 filed May 24, 2012, by K. Dutta.

### FIELD OF THE INVENTION

This invention concerns a system for erasing features in a displayable three dimensional (3D) medical image volume.

### BACKGROUND OF THE INVENTION

Blood vessel analysis performed on a 3D image volume is often affected by noise and unwanted touching vessels present in the region of interest of the 3D image volume. In one known system a volume punching function is used to remove unwanted parts of a 3D volume. However, the volume punching process is tedious and burdensome involving multiple repetitive erasure actions to erase an unwanted volume portion. A system according to invention principles addresses this deficiency and related problems.

### SUMMARY OF THE INVENTION

A system provides 3D Eraser functions for erasing unwanted touching vessels, for example, from a 3D volume to increase user viewability of a vessel display image for analysis. A system erases features in a displayable three dimensional (3D) medical image volume comprising multiple image slices. An erasure cursor coordinate detector detects two dimensional (2D) location coordinates identifying location of a movable erasure cursor in a displayed image within the medical image volume. A data processor translates the detected erasure cursor 2D location coordinates to corresponding 2D pixel coordinates within an image slice in the 3D medical image volume. The data processor sets luminance values of pixels corresponding to the 2D pixel coordinates of the image slice to a background luminance value of the image slice to provide erased pixels corresponding to erasure cursor locations having an identifier. A display processor generates data representing a display image showing the image slice with the set background luminance values of the erased pixels.

### BRIEF DESCRIPTION OF THE DRAWING

FIG. 1 shows a system for erasing features in a displayable three dimensional (3D) medical image volume comprising multiple image slices, according to invention principles.

FIG. 2 shows system processing steps for erasing features in a displayable three dimensional (3D) medical image volume comprising multiple image slices, according to invention principles.

FIG. 3 shows processing steps involved in using a cursor for erasing features, according to invention principles.

FIG. 4 shows selection of an eraser from different size erasers, according to invention principles.

FIG. 5 shows a flowchart of a process used for operation of a 3D eraser, according to invention principles.

FIG. 6 shows a flowchart of a process used by a system for erasing features in a displayable three dimensional (3D) medical image volume comprising a plurality of image slices, according to invention principles.

### DETAILED DESCRIPTION OF THE INVENTION

A 3D erasure system is usable to clean a 3D image volume and eliminate unwanted vessel segments within the 3D volume. The system advantageously facilitates and expedites a 3D image volume cleanup process removing unwanted parts of a 3D volume in comparison with known systems by erasing unwanted touching vessels, for example, to increase user viewability of a vessel display image for analysis. A user is not limited by having to select a region of interest of an imaging volume followed by selection of an inside or outside cleaning option for cropping each individual single region. Rather, a user selects an Erasure cursor in a user interface (UI) and is able to move the Erasure cursor around an image volume to erase unwanted features until an erasing task is complete.

A system 3D Eraser function is used to eliminate noise and unwanted touching vessels from a 3D image volume to increase clarity of desired vessels for analysis. A user is provided with an option to erase unwanted vessel features and noise from an image volume region of interest before initiating a vessel analysis process. The cleaning of the unwanted vessel parts and features comprises selecting a 3D erasure cursor of selectable size from multiple different size cursors available via a UI and moving it around the vessel region. A user selects an erasure cursor of a particular size from multiple different sizes based on the size of the area to be cleaned.

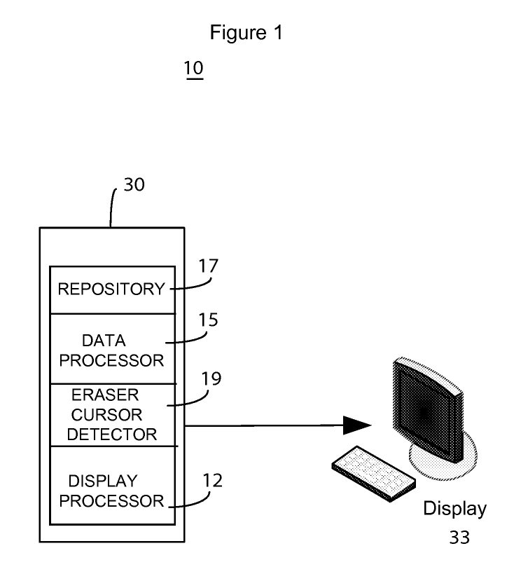

FIG. 1 shows system 10 for erasing features in a displayable three dimensional (3D) medical image volume comprising multiple image slices and presented on monitor 33. System 10 employs at least one processing device 30 for processing images and an image volume dataset acquired by an imaging system for display on monitor 33. Specifically, processing device 30 comprises at least one computer, server, microprocessor, programmed logic device or other processing device comprising repository 17, data processor 15, erasure cursor coordinate detector 19 and display processor 12 presenting a user interface display image on monitor 33. Erasure cursor coordinate detector 19 detects two dimensional (2D) location coordinates identifying location of a movable erasure cursor in a displayed image within a medical image volume. Data processor 15 translates the detected erasure cursor 2D location coordinates to corresponding 2D pixel coordinates within an image slice in the 3D medical image volume. Further, the image slice has an identifier. Processor 15 sets luminance values of pixels corresponding to the 2D pixel coordinates of the image slice to a background luminance value of the image slice to provide erased pixels corresponding to erasure cursor locations where the image slice has an identifier. Display processor 12 generates data representing a display image showing the image slice with the set background luminance values of the erased pixels.

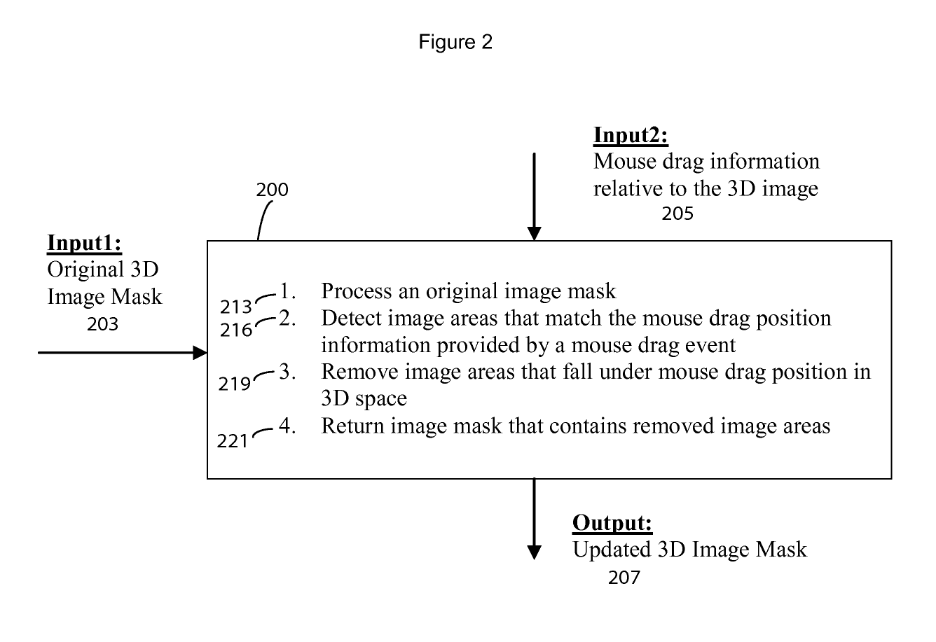

FIG. 2 shows system processing steps for erasing features in a displayable three dimensional (3D) medical image volume comprising multiple image slices. Method 200 comprising steps 213, 216, 219 and 222 processes an original 3D image mask 203 comprising a potion of the 3D medical image volume and data 205 indicating mouse displacement relative to a 3D image to provide an updated 3D image mask 207. Processor 15 tracks a mouse displacement event, interprets mouse movement of an erasure cursor as a virtual 3D erasure function and updates a 3D image volume data set in response. The system is sufficiently fast to display and erase a 3D image volume in real time.

In step 213 processor 15 processes original image mask 203 by detecting image areas in step 216 that match mouse drag position information provided in response to a mouse drag event. In step 219, processor 15 removes image areas that fall under a mouse drag position in 3D space and in step 222 returns an updated image mask that contains removed image areas.

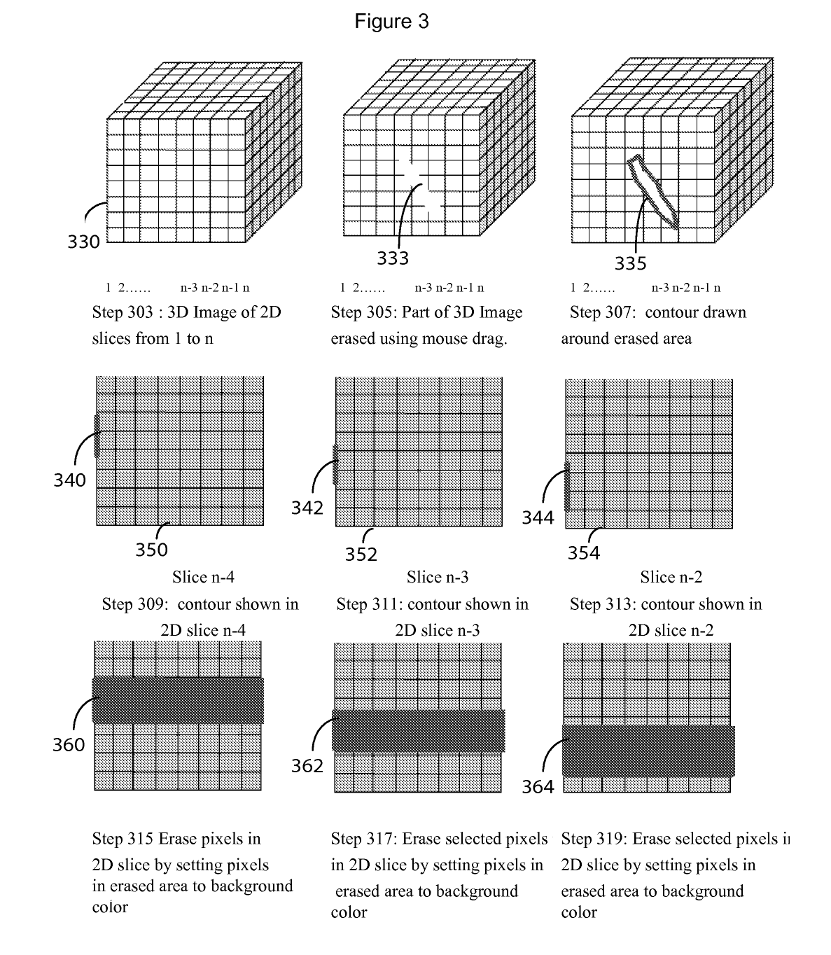

FIG. 3 shows processing steps involved in using a cursor for erasing features. Medical image volume 330 comprising slices 1 to n is presented on monitor 33 in step 303. A user employs an erasure cursor to erase portion 333 of the 3D image volume in step 305 and processor 15 automatically draws contour 335 around the erased area in step 307. Processor 15 identifies mouse drag area 333 in 3D image volume 330. In response to a mouse drag operation being complete, processor 15 generates contour 335 around the mouse drag volume in 3D to identify the erased volume of interest. Processor 15 generates the contour using erasure cursor movement data and data identifying user commands in a 3D viewer application to determine contour 335 around a volume of interest to be erased.

In response to generation of contour 335, processor 15 maps 3D coordinates generated during a cursor drag event to 2D slice coordinates. A 3D coordinate provided by the cursor drag event is in (x, y, z) format, where z correspond to a 2D slice number. The 3D coordinate is mapped to a 2D coordinate in the format (x,y) for the affected 2D slice. Sets of 2D coordinates are processed for affected slices in steps 309, 311 and 313. Affected rows in each of the affected 2D slices are processed by setting pixel color luminance values corresponding to the 2D coordinates concerned to a background luminance values, hence providing the erase operation. An original 3D mask image volume is modified by altering the affected 2D slices and a new modified mask is provided and displayed. In steps 309, 311 and 313 the 2D image slices 350, 352 and 354 comprise slices n-4, n-3 and n-2 respectively through volume 330 that are processed by processor 15 to provide 2D coordinates for contour 335 in the 2D slices in areas 340, 342 and 344 respectively. In steps 315, 317 and 319, processor 15 erases selected pixels in 2D slice 350, 352 and 354 by setting pixels in the slice area corresponding to area 333 to background color as shown by portions 360, 362 and 364, respectively. A cursor erase operation is repeated for each erasure cursor drag event. The system processes the affected 2D slices, and not an entire 3D volume in order to accelerate processing for real time update and image data display on monitor 33.

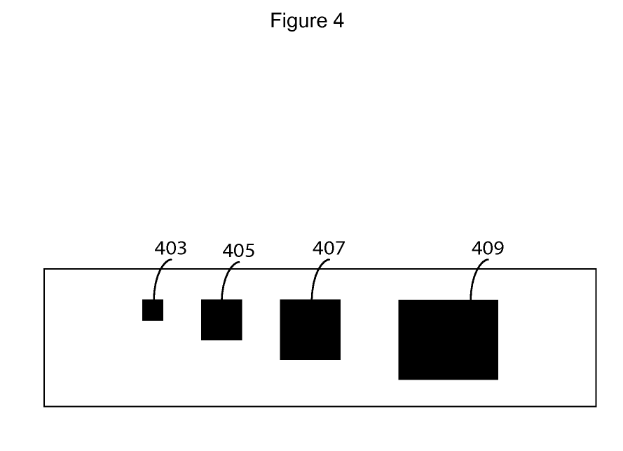

FIG. 4 shows selection of an eraser from different size erasure cursors 403, 405, 407 and 409. A user interface display image presented on monitor 33 enables a user to select an erasure cursor from cursors of multiple different sizes and allows the user to select and drag a selected erasure cursor to a 3D image volume to simulate a virtual erasing process using a cursor drag function. A user selects a desired size erasure cursor by selecting an erasure cursor object from different size erasure cursors 403, 405, 407 and 409 depending on the size of the erase operation to be performed.

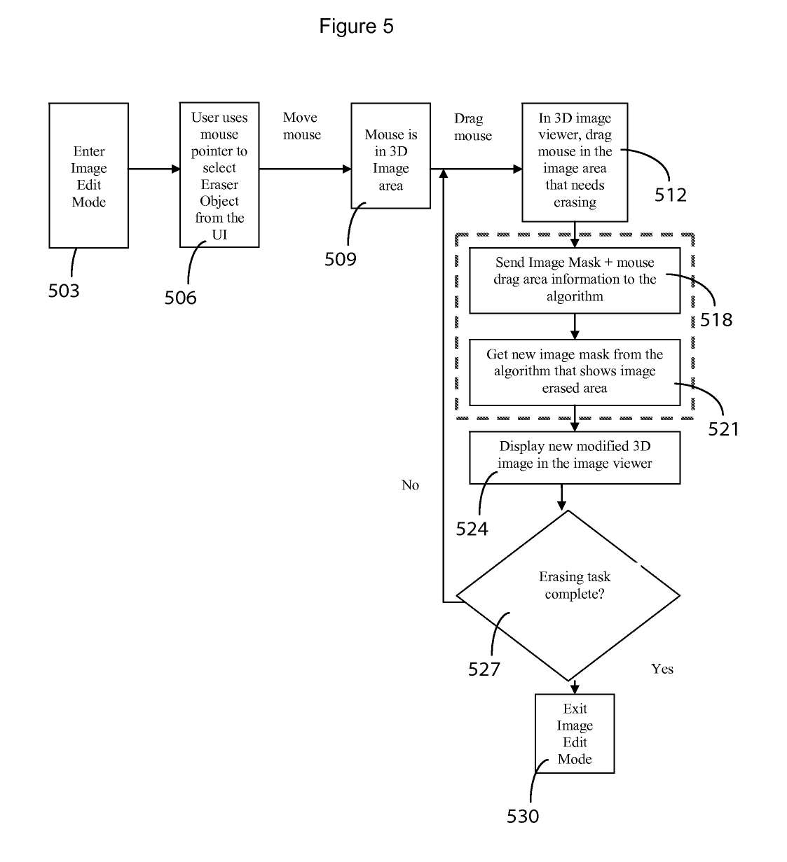

FIG. 5 shows a flowchart of a process used for operation of a 3D eraser. A user in step 506 selects an erasure cursor size from multiple sizes shown in FIG. 4 using a mouse, for example, in response to user initiation of image edit mode in step 503. A user moves the erasure cursor in step 512 by mouse movement to erase an image area of a 3D image volume displayed in a 3D viewer on monitor 33, in response to moving the erasure cursor into the 3D volume in step 509. In steps 518 and step 521 processor 15 processes an image mask plus mouse drag area information to provide a new image mask showing the erased area using the process of FIG. 3 as previously described. Display processor 12 in step 524 displays a new modified 3D image in an image viewer and in step 527 if it is determined erasure is complete processor 15 exits the image edit mode in step 530. If it is determined in step 527 that erasure is incomplete, processor 15 iteratively executes steps 512, 518, 521, 524 until erasing is complete.

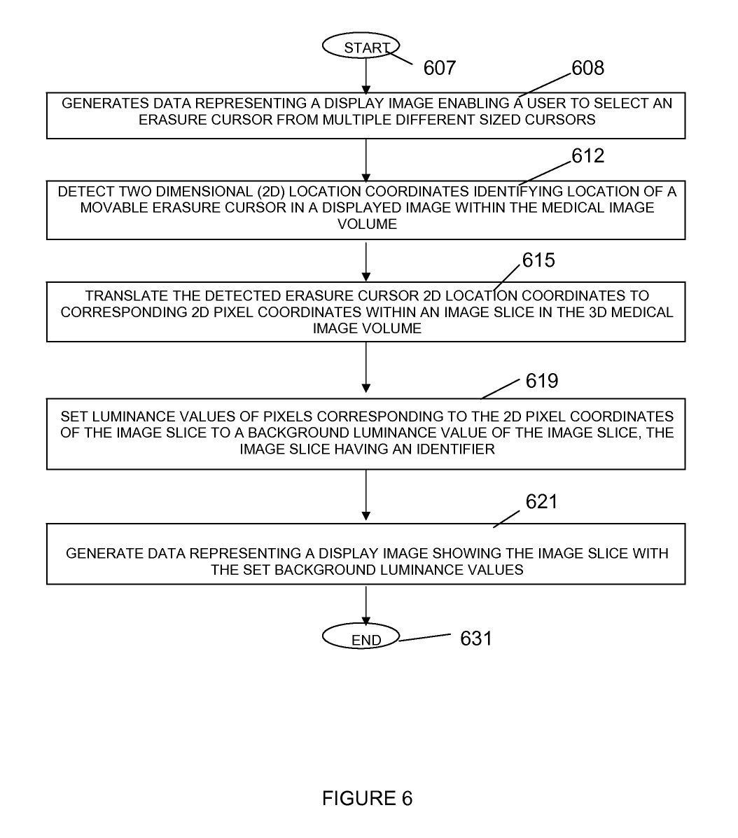

FIG. 6 shows a flowchart of a process used by system 10 (FIG. 1) for erasing features in a displayable three dimensional (3D) medical image volume comprising multiple image slices. In step 608 following the start at step 607, processor 12 generates data representing a display image enabling a user to select an erasure cursor from multiple different sized cursors. Erasure cursor coordinate detector 19 in step 612 detects two dimensional (2D) location coordinates identifying location of a movable selected erasure cursor in a displayed image within the medical image volume. In step 615, data processor 15 translates the detected erasure cursor 2D location coordinates to corresponding 2D pixel coordinates within an image slice in the 3D medical image volume. In one embodiment, processor 15 translates the detected erasure cursor 2D location coordinates to corresponding 2D pixel coordinates within first and second different image slices in the 3D medical image volume where the first and second different image slices have first and second different identifiers. Processor 15 identifies a boundary contour of an erasure 3D region within the volume.

Processor 15 in step 619 sets luminance values of pixels corresponding to the 2D pixel coordinates of the image slice (having an identifier) and pixels within the 3D region within the volume to a background luminance value of the image slice to provide erased pixels corresponding to erasure cursor locations. Processor 15 in one embodiment, also sets luminance values of pixels corresponding to the 2D pixel coordinates of the first and second different image slices to a background luminance value of the corresponding image slice. Display processor 12 in step 621 generates data representing a display image showing the image slice with the set background luminance values of the erased pixels. The process of FIG. 6 terminates at step 631.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. A histogram of an image is a graph that plots the number of pixels (on the y-axis herein) in the image having a specific intensity value (on the x-axis herein) against the range of available intensity values. The resultant curve is useful in evaluating image content and can be used to process the image for improved display (e.g. enhancing contrast).

The system and processes of FIGS. 1-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system 3D eraser function enables user selection of a 3D erasure cursor of selectable size from multiple different size cursors via a UI for use in erasing areas within a 3D image volume to increase clarity of desired vessels for analysis, for example. Further, the processes and applications may, in alternative embodiments, be located on one or more (e.g., distributed) processing devices on a network linking the units FIG. 1. Any of the functions and steps provided in FIGS. 1-6 may be implemented in hardware, software or a combination of both. No claim element herein is to be construed under the provisions of 35 U.S.C. 112, sixth paragraph, unless the element is expressly recited using the phrase “means for.”

What is claimed is:

1. A system for erasing features in a displayable three dimensional (3D) medical image volume comprising a plurality of image slices, comprising:
an erasure cursor coordinate detector configured for detecting two dimensional (2D) location coordinates identifying location of a movable erasure cursor in a displayed image within said medical image volume;
a data processor configured for,
translating the detected erasure cursor 2D location coordinates to corresponding 2D pixel coordinates within an image slice in the 3D medical image volume and
setting luminance values of pixels corresponding to said 2D pixel coordinates of said image slice to a background luminance value of said image slice to provide erased pixels corresponding to erasure cursor locations, said image slice having an identifier; and
a display processor configured for generating data representing a display image showing said image slice with the set background luminance values of said erased pixels.

2. A system according to claim 1, wherein
said data processor,
translates the detected erasure cursor 2D location coordinates to corresponding 2D pixel coordinates within first and second different image slices in the 3D medical image volume and
sets luminance values of pixels corresponding to said 2D pixel coordinates of said first and second different image slices to a background luminance value of the corresponding image slice, said first and second different image slices having first and second different identifiers.

3. A system according to claim 1, wherein
said data processor translates the detected erasure cursor 2D location coordinates to corresponding 2D pixel coordinates within first and second different image slices in the 3D medical image volume, said first and second different image slices having first and second different identifiers and said data processor identifies a boundary contour of an erasure 3D region within said volume.

4. A system according to claim 3, wherein
said data processor sets luminance values of pixels within said 3D region within said volume to a background luminance value of corresponding image slices through said region.

5. A system according to claim 1, wherein
said display processor generates data representing a display image enabling a user to select an erasure cursor from a plurality of different sized cursors.

6. A method for erasing features in a displayable three dimensional (3D) medical image volume comprising a plurality of image slices, comprising the activities of:
detecting two dimensional (2D) location coordinates identifying location of a movable erasure cursor in a displayed image within said medical image volume;
translating the detected erasure cursor 2D location coordinates to corresponding 2D pixel coordinates within an image slice in the 3D medical image volume and
setting luminance values of pixels corresponding to said 2D pixel coordinates of said image slice to a background luminance value of said image slice to provide erased pixels corresponding to erasure cursor locations, said image slice having an identifier; and
generating data representing a display image showing said image slice with the set background luminance values of said erased pixels.

7. A method according to claim 6, including the activities of
translating the detected erasure cursor 2D location coordinates to corresponding 2D pixel coordinates within first and second different image slices in the 3D medical image volume and
setting luminance values of pixels corresponding to said 2D pixel coordinates of said first and second different image slices to a background luminance value of the corresponding image slice, said first and second different image slices having first and second different identifiers.

8. A method according to claim 6, including the activities of
translating the detected erasure cursor 2D location coordinates to corresponding 2D pixel coordinates within first and second different image slices in the 3D medical image volume, said first and second different image slices having first and second different identifiers and
identifying a boundary contour of an erasure 3D region within said volume.

9. A method according to claim 10, wherein
setting luminance values of pixels within said 3D region within said volume to a background luminance value of corresponding image slices through said region.

10. A method according to claim 1, including the activity of
generating data representing a display image enabling a user to select an erasure cursor from a plurality of different sized cursors.

11. A tangible storage medium storing programmed instruction comprising a method for erasing features in a displayable three dimensional (3D) medical image volume comprising a plurality of image slices, comprising the activities of:
detecting two dimensional (2D) location coordinates identifying location of a movable erasure cursor in a displayed image within said medical image volume;
translating the detected erasure cursor 2D location coordinates to corresponding 2D pixel coordinates within an image slice in the 3D medical image volume and
setting luminance values of pixels corresponding to said 2D pixel coordinates of said image slice to a background luminance value of said image slice to provide erased pixels corresponding to erasure cursor locations, said image slice having an identifier; and
generating data representing a display image showing said image slice with the set background luminance values of said erased pixels.
